(19) United States
(12) Patent Application Publication
(10) Pub. No.: US 2009/0229322 A1
(43) Pub. Date: Sep. 17, 2009

(54) Storm door lock assembly

(75) Inventor: Louis Chou, Taipei (TW)

Correspondence Address: Louis Chou, P.O. Box 44-2049, Taipei, 10668, TW

(73) Assignee: LUTER ENTERPRISE CO., LTD.

(21) Appl. No.: 12/076,291

(22) Filed: Mar. 17, 2008

(51) Int. Cl. E05B 59/00; E05B 63/14

(52) U.S. Cl. 70/107

(57) ABSTRACT

A storm door lock assembly includes an inner member and an outer member with a movable member located therebetween, the inner member is connected with an inside door knob and the outer member is connected with an outside door knob. The inner and outer members each can operate the latch bolt. A mounting member is connected to the movable member and mounted to the dead bolt and a spring board is biased to the dead bolt to retract the dead bolt into the escutcheon. When the inside door knob is rotated, the mounting member is lifted by the movable member and the dead bolt is freely pushed by the spring board to retract into the escutcheon when the mounting member is lifted. The latch bolt and the dead bolt are both retracted into the escutcheon by rotating the inside door knob.

### BACKGROUND OF THE INVENTION

(1) Field of the Invention

The present invention relates to a storm door lock assembly which can be opened from inside by one action.

(2) Description of the Prior Art

A conventional door lock generally includes a latch bolt and a dead bolt, the latch bolt is operated by rotating the door knob and the dead bolt can only be operated by using a key to unlock the lock. The user can easily open the door from outside simply by rotating the door knob or using the key, the latch bolt and the dead bolt are both operated and the door can be opened. However, the user cannot open the door from inside by one action as from the outside, the user has to rotate the inside door knob by one hand and rotate the other knob to remove the latch bolt.

Although an improved door lock assembly is developed and allows the user to open the door from inside by one action, the number of parts of this type of door assembly makes the assembling processes complicated and time-consuming. Besides, the cost of fabrication is high and therefore reduces the competitiveness in the market.

The present invention intends to provide a storm door assembly which involves a simple structure and allows the user to open the door by one action from outside or inside.

### SUMMARY OF THE INVENTION

The present invention relates to a storm door lock assembly that comprises an escutcheon composed of a front panel, a rear panel and a face plate connected between the front panel and the rear panel. Each of the front and rear panels includes a door knob hole and a lock hole so that an outside door knob and an inside door knob (both not shown) are respectively connected to the door knob holes. The lock holes are cooperated with a lock set (not shown). The face plate includes a latch hole and a bolt hole. A latch bolt retractably extends through the latch hole and a dead bolt retractably extends through the bolt hole of the face plate.

An operation unit is located between the front and rear panels and includes an outer member, an inner member and a movable member which is located between the outer and inner members. The outer member includes a first link, a first push bar and a first extension extending radially therefrom. The outer member is connected with an outside door knob. The inner member includes a second link, a second push bar and a second extension extending radially therefrom. The inner member is connected with an inside door knob. The first and second links are connected with the movable member. The first and second push bars drive the latch bolt to retract into the escutcheon.

A mounting member is mounted to the dead bolt. A boss extends from one side of the dead bolt and movably engaged with an elongate hole in the mounting member. The mounting member includes a positioning piece extending therefrom which is movably engaged with the positioning hole in the front panel. The mounting member is connected to the movable member and biased by a spring. A spring board has one end pivotably connected to the escutcheon and the other end of the spring board is inserted into a bottom chamber in the dead bolt.

The primary object of the present invention is to provide a storm door lock assembly which can be unlocked by rotating the inside door knob.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the storm door lock assembly of the present invention;

FIG. 2 shows that the dead bolt is retracted in the escutcheon and the latch bolt extends from the face plate, the door is not locked;

FIG. 3 shows that both of the dead bolt and the latch bolt extend from the face plate, the door is locked;

FIG. 4 shows that the operation unit is operated by rotating the inside door knob and the latch bolt is retracted into the escutcheon, and

FIG. 5 shows that the dead bolt is retracted into the escutcheon when the mounted member is lifted to a position and the dead bolt is retracted into the escutcheon by the spring board, the door is unlocked and can be opened.

### DETAILED DESCRIPTION OF THE PREFERRED EMBODIMENTS

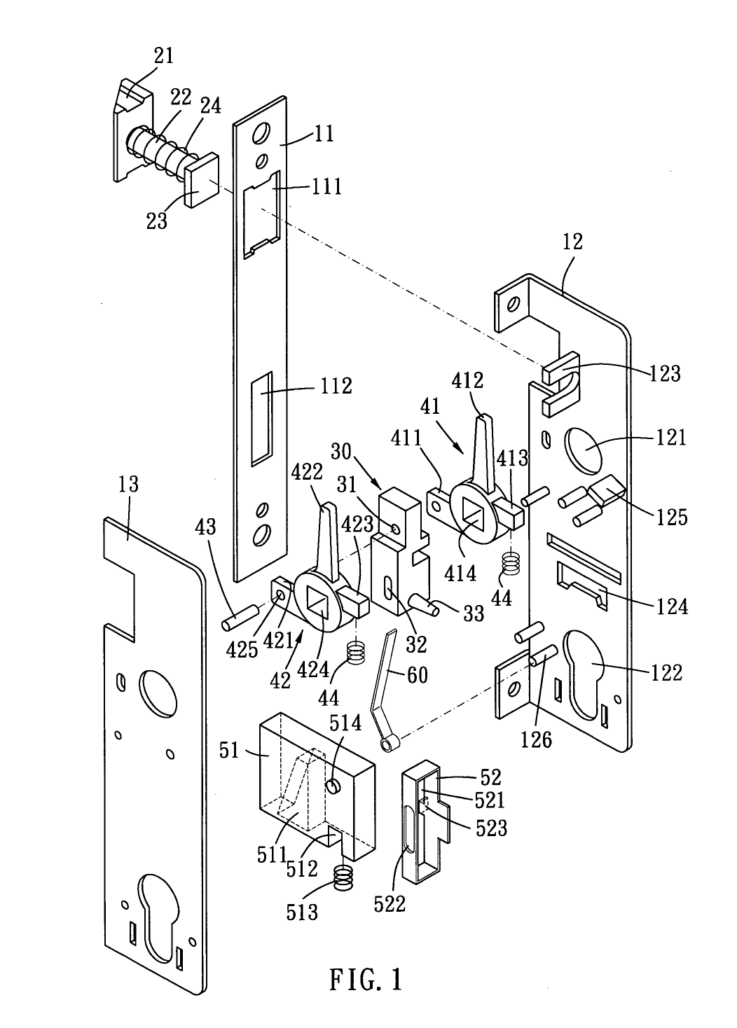

Referring to FIG. 1, the storm door lock assembly of the present invention comprises an escutcheon 10 composed of a front panel 12, a rear panel 13 and a face plate 11 connected between the front panel 12 and the rear panel 13. Each of the front and rear panels 12, 13 includes a door knob hole 121 and a lock hole 122 so that an outside door knob and an inside door knob (both not shown) are respectively connected to the door knob holes of the front panel 12 and the rear panel 13. The lock holes 122 are cooperated with a lock set (not shown). The front panel 12 includes an inverted U-shaped positioning hole 124 which includes a horizontal passage. The face plate 11 includes a latch hole 111 and a bolt hole 112. A latch bolt 21 retractably extends through the latch hole 111 of the face plate 11 and a dead bolt 51 retractably extends through the bolt hole 112 of the face plate 11. A shank 22 has one end connected to the latch bolt 21 and a stop 23 is connected to the other of the shank 22, a first spring 24 is mounted to the shank 22 and biased between the latch bolt 21 and the stop 23. A U-shaped member 123 extends from an inside of the front panel 12 and the shank 22 is movably engaged with the U-shaped member 123 and the stop 23 is stopped by the U-shaped member 123.

An operation unit is located between the front and rear panels 12, 13 and includes an outer member 41, an inner member 42 and a movable member 30 which is located between the outer and inner members 41, 42. The outer member 41 includes a first link 411, a first push bar 412 and a first extension 413 extending radially therefrom. A first polygonal hole 414 is defined through the outer member 41 so as to be connected with an outside door knob (not shown). The inner member 42 includes a second link 421, a second push bar 422 and a second extension 423 extending radially therefrom. A second polygonal hole 424 is defined through the inner member 42 so as to be connected with an inside door knob (not shown). The first link 411 has a hole and the second link 421 has another hole 425, the movable member 30 has a passage 31, a pin 43 extends through the two holes in the first and second links 411, 421 and the passage 31 in the movable member 30. The first and second push bars 412, 422 are located between the stop 23 and the U-shaped member 123 so that when either of the outer member 41 or the inner member 42 is rotated, the latch bolt 21 is retracted into the escutcheon 10. A rod 33 extends from the movable member 30 and a through hole 521 is defined through the mounting member 52, the rod 33 extends through the through hole 521. The movable member 30 further includes an elongate slot 32 and a rod extending from the inside of the front panel 12 movably extends through the elongate slot 32 so that the movable member 30 can be traveled a distance the same as the length of the elongate slot 32. A support board 125 extends from the inside of the front panel 12 and two second springs 44 are located between the support board 125 and the first and second extensions 413, 423.

A dead bolt 51 retractably extends through the bolt hole 112 in the face plate 11 and a mounting member 52 is mounted to the dead bolt 51. A boss 514 extends from one side of the dead bolt 51 and movably engaged with an elongate hole 522 in the mounting member 52. The mounting member 52 includes a positioning piece 523 extending therefrom which is movably engaged with the positioning hole 124 in the front panel 12. It is noted that the positioning hole 124 is an inverted U-shaped hole and includes a horizontal path through which the positioning piece 523 passes. The positioning piece 523 can be positioned in two inner ends of the positioning hole 124. The dead bolt 51 has a recess 512 defined in a bottom thereof and a third spring 513 is located in the recess 512 and biased between an inner end of the mounting member 52 and an inner end of the recess 512. A spring board 60 has one end pivotably connected to a rod 126 on the front panel 12 of the escutcheon 10 and the other end of the spring board 60 is inserted into a bottom chamber 511 in the dead bolt 51.

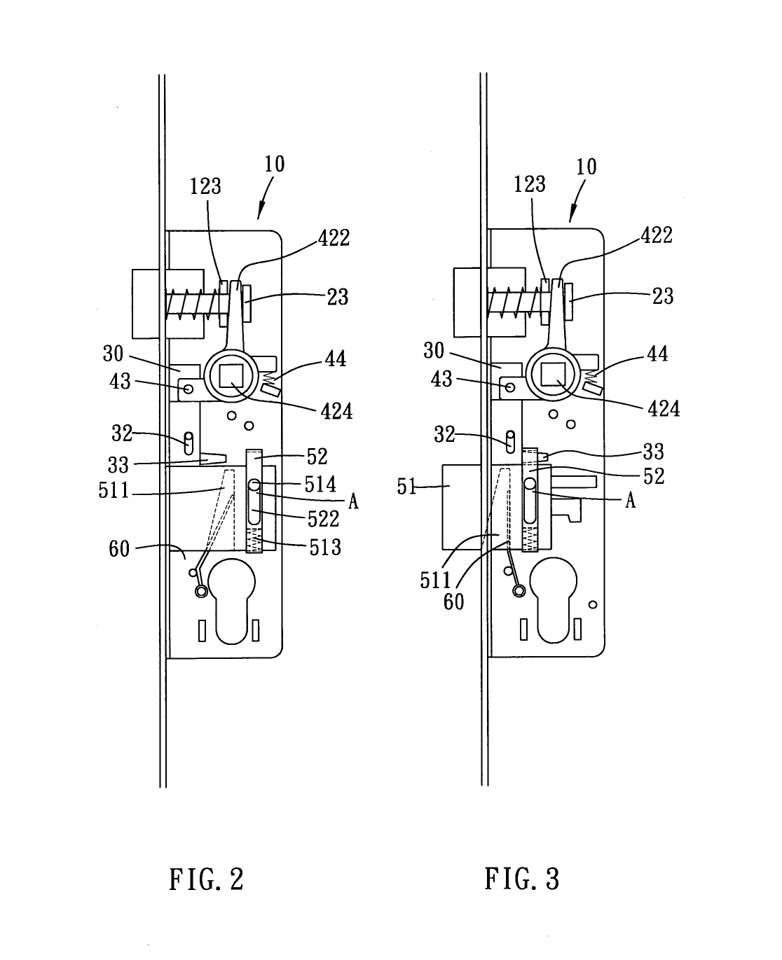

FIG. 2 shows that the dead bolt 51 is retracted in the escutcheon 10 and the latch bolt 21 extends from the face plate 11, the door is not locked. The user can retract the latch bolt 21 from inside or outside of the door. FIG. 3 shows that both of the dead bolt 51 and the latch bolt 21 extend from the face plate 11, the door is locked and the positioning piece 523 is located at the position “A” in one inner end of the positioning hole 124.

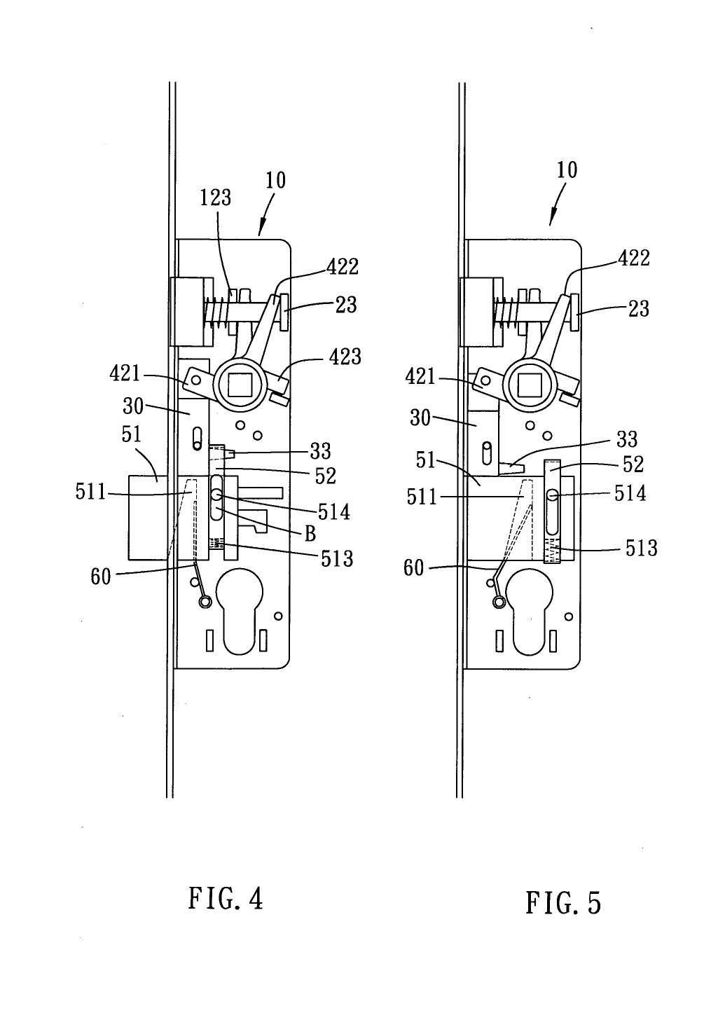

FIGS. 4 and 5 show two consecutive actions when unlocking and opening the door, the user users a key (not shown) to unlock the lock core (not shown) in the lock holes 122 so as to rotate the outside door knob. The outer member 41 is then rotated to retract the latch bolt 21 and lift the movable member 30 upward. The movement of the movable member 30 lifts the mounting member 52 by the rod 33 on the movable member 30, so that the third spring 513 is compressed as shown. When the positioning piece 523 is moved to the horizontal passage at position “B” in the positioning hole 124, the dead bolt 51 is pulled by the spring board 60 to retract into the escutcheon 10. the door can be opened.

The door can be opened by rotating either of the inside door knob or the outside door knob to operate the operation unit, the operation of the operation unit then lifts the mounting member 52 to retract the dead bolt 51.

While we have shown and described the embodiment in accordance with the present invention, it should be clear to those skilled in the art that further embodiments may be made without departing from the scope of the present invention.

What is claimed is:

1. A storm door lock assembly comprising:
an escutcheon including a front panel, a rear panel and a face plate which is connected between the front panel and the rear panel, each of the front and rear panels includes a door knob hole and a lock hole, the front panel including a positioning hole, the face plate including a latch hole and a bolt hole;
a latch bolt retractably extending through the latch hole of the face plate;
an operation unit located between the front and rear panels and including an outer member, an inner member and a movable member which is located between the outer and inner members, the outer member including a first link, a first push bar and a first extension extending radially therefrom, a first polygonal hole defined through the outer member, the outer member being adapted connected with an outside door knob, the inner member including a second link, a second push bar and a second extension extending radially therefrom, a second polygonal hole defined through the inner member, the inner member being adapted connected with an inside door knob, the first and second links connected with the movable member, the first and second push bars driving the latch bolt to retract into the escutcheon;
a dead bolt retractably extending through the bolt hole in the face plate and a mounting member mounted to the dead bolt, a boss extending from one side of the dead bolt and movably engaged with an elongate hole in the mounting member, the mounting member including a positioning piece extending therefrom which is movably engaged with the positioning hole in the front panel, the mounting member connected to the movable member and biased by a spring, and
a spring board having one end pivotably connected to the escutcheon and the other end of the spring board inserted into a bottom chamber in the dead bolt.

2. The storm door lock assembly as claimed in claim 1, wherein a shank has one end connected to the latch bolt and a stop is connected to the other of the shank, another spring is mounted to the shank and biased between the latch bolt and the stop, a U-shaped member extends from an inside of the front panel and the shank is movably engaged with the U-shaped member and the stop is stopped by the U-shaped member, the first and second push bars are located between the stop and the U-shaped member.

3. The storm door lock assembly as claimed in claim 2, wherein a rod extends from the movable member and a through hole is defined through the mounting member, the rod extends through the through hole.

4. The storm door lock assembly as claimed in claim 1, wherein the positioning hole is an inverted U-shaped hole and includes a horizontal path through which the positioning piece passes, the positioning piece are positioned in two inner ends of the positioning hole.

5. The storm door lock assembly as claimed in claim 1, wherein the dead bolt has a recess defined in a bottom thereof and yet another spring is located in the recess and biased between an inner end of the mounting member and an inner end of the recess.

6. The storm door lock assembly as claimed in claim 1, wherein the first link has a hole and the second link has another hole, the movable member has a passage, a pin extends through the two holes in the first and second links and the passage in the movable member.

7. The storm door lock assembly as claimed in claim 1, wherein a support board extends from an inside of the front panel and two springs are located between the support board and the first and second extensions.
